(19) United States
(12) Patent Application Publication
(10) Pub. No.: US 2026/0170901 A1
(43) Pub. Date: Jun. 18, 2026

(54) GAMING SYSTEMS AND METHODS WITH MULTISTAGE FEATURE

(71) Applicant: LNW Gaming, Inc., Las Vegas, NV (US)

(72) Inventors: Kellen Dale, Washoe Valley, NV (US); Richard Milosevich, Las Vegas, NV (US); Amy Robards, Sparks, NV (US)

(21) Appl. No.: 19/405,668

(22) Filed: Dec. 2, 2025

Related U.S. Application Data
(60) Provisional application No. 63/733,041, filed on Dec. 12, 2024.

(51) Int. Cl. G07F 17/32

(52) U.S. Cl. CPC G07F 17/3213; G07F 17/3267

(57) ABSTRACT

There is provided a gaming system, machine, and method that utilize a presentation assembly to present a primary game interface including symbol positions, present a trigger game outcome by populating the symbol positions with randomly-selected symbols, animate a transition to a secondary game interface in response to detecting a trigger event by updating the symbol positions into a set of active positions including any symbol positions occupied by value-bearing symbols and a set of inactive positions, present a secondary game outcome by selectively populating the active positions with award elements, update, in response to a first award element occupying a first active position, award indicia associated with the first active position as a function of an award indicated by the first award element, and present an award sequence in response to an award event for an award based on the award indicia associated with the first active position.

### CROSS-REFERENCE TO RELATED APPLICATIONS

This application claims the benefit of priority to U.S. Provisional Application No. 63/733,041, filed Dec. 12, 2024, the contents of which are incorporated herein by reference in their entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2024, LNW Gaming, Inc.

### FIELD OF THE INVENTION

The present invention relates to a technological improvement to gaming systems, gaming machines, and methods and, more particularly, to new and improved animations in connection with a multistage persistence feature.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

According to an embodiment of the present invention, there is provided a gaming system, gaming machine, and method that utilize a presentation assembly configured to present a primary game interface including a plurality of symbol positions, present a trigger game outcome by populating the symbol positions with randomly-selected symbols that include at least one value-bearing symbol having a respective award indicia visibly indicating an award value, animate, in response to detecting a trigger event from the trigger game outcome, the primary game interface to transition to a secondary game interface by visually updating the symbol positions into at least a set of active positions including any symbol positions occupied by the value-bearing symbols and a set of inactive positions visually distinct from the active positions, wherein the active positions are associated with the respective award indicia of the respective value-bearing symbols, present a secondary game outcome by selectively populating the active positions with award elements selected from a set of available award elements, update, in response to the secondary game outcome including a first award element occupying a first active position, the award indicia associated with the first active position at least partially as a function of an award visibly indicated by the first award element, and present, in response to an award event, an award sequence for an award at least partially based on the award indicia associated with the first active position. The game-logic circuitry may be at least partially integrated with the gaming machine or within a separate computing device in communication with the gaming machine (e.g., a gaming server).

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present disclosure.

FIG. 2 is a block diagram of a gaming system according to an embodiment of the present disclosure.

FIG. 3 is a flow diagram for a data processing method that corresponds to instructions executed by a controller, according to one or more aspects of the present disclosure.

FIG. 4 is an example game interface of a gaming system, according to one or more aspects of the present disclosure.

FIG. 5A is an example game interface of a gaming system in a first state with a trigger event, according to one or more aspects of the present disclosure.

FIG. 5B is the game interface of FIG. 5A in a second state with a secondary game feature initiated, according to one or more aspects of the present disclosure.

FIG. 5C is the game interface shown in FIG. 5A in a third state with a secondary game outcome shown, according to one or more aspects of the present disclosure.

FIG. 5D is the game interface shown in FIG. 5A in a fourth state with the secondary game outcome of the third state applied to the underlying symbols, according to one or more aspects of the present disclosure.

FIG. 5E is the game interface shown in FIG. 5A in a fifth state following the fourth state with the remaining symbols being returned from the array of FIG. 5A in a unified presentation, according to one or more aspects of the present disclosure.

FIG. 6A is an example game interface of a gaming system in a first state with a trigger event, according to one or more aspects of the present disclosure.

FIG. 6B is the game interface of FIG. 6A in a second state with award indicia for active symbol positions, according to one or more aspects of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

Embodiments of the present invention comprise an innovative application of data processing steps that, when implemented by game-logic circuitry, direct an electronic display device to present a multistage symbol-value aggregation process that minimizes processing overhead by utilizing numbered indicia to represent credit values instead of complex, fanciful game images. Further, the process aggregates displayed values borne by special symbols (i.e., value-bearing symbols) according to stored, variable criteria. In this way, the value-bearing symbols provide building blocks for innumerable different aggregation sequences simply by manipulating the aggregation criteria associated with the value-bearing symbols, resulting in fewer rules needed for the aggregation process than would be necessary for calculating values of winning symbol combinations enumerated in stored paytables, as found in prior art reel-spinning routines. At the same time, embodiments of the present invention provide a straightforward, what-you-see-is-what-you-get (WYSIWYG) visual presentation that is simple to understand and, therefore, effective in generating player excitement and enthusiasm. The result is a highly flexible value-aggregation process that can be easily adapted to any theme/brand while remaining easily understood by players.

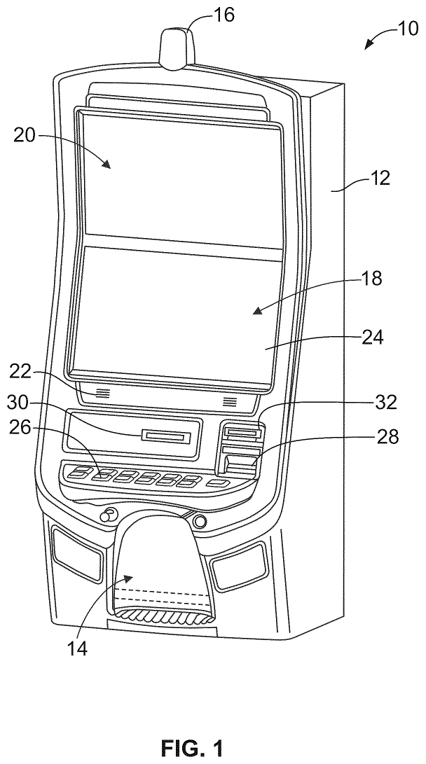

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

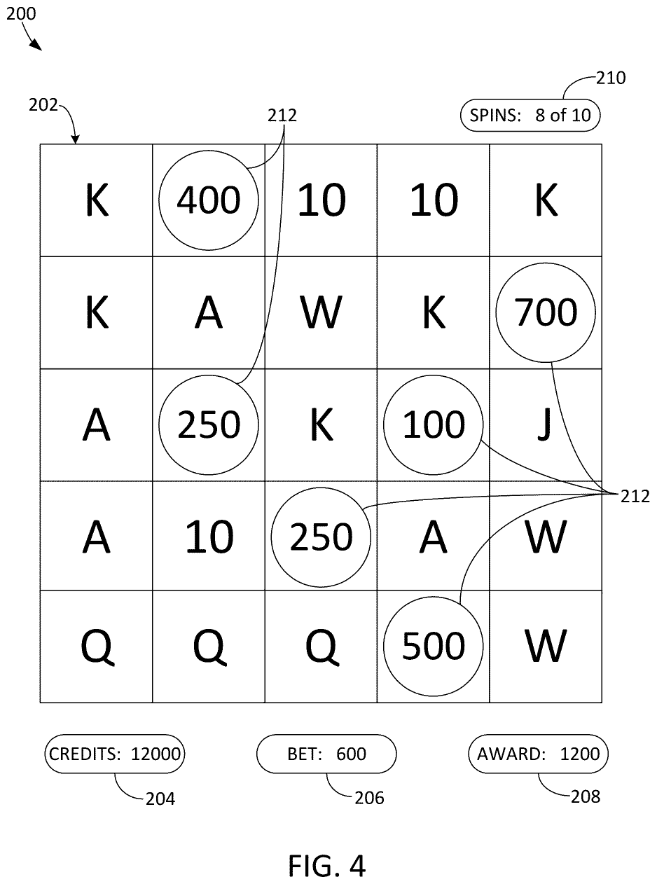

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 204 (see FIG. 4). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 204 (see FIG. 4), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

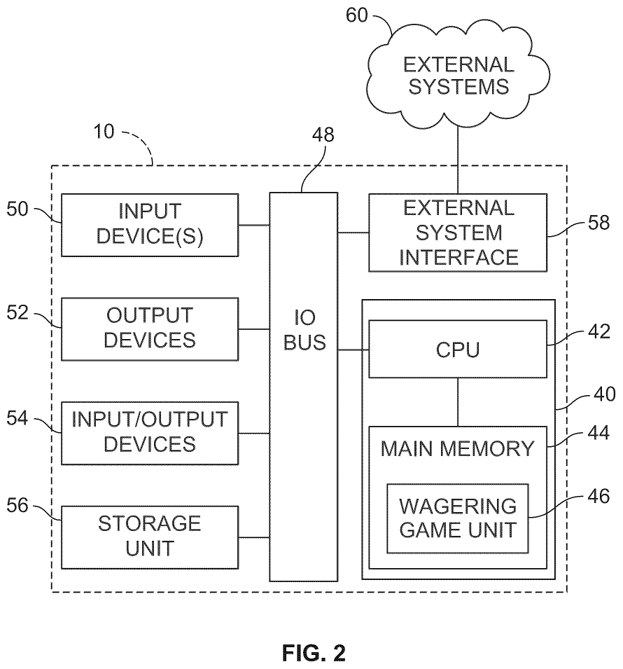

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40 —whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success, and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S. A 5:12-23, 5:12-45, and all other relevant provisions of the New Jersey Casino Control Act. As can be seen from the description herein, the gaming machine 10 may be implemented with hardware and software architectures, circuitry, and other special features that differentiate it from general-purpose computers (e.g., desktop PCs, laptops, and tablets).

The gaming systems and methods described herein include a multistage persistence feature. For example, an initial stage is used to divide symbol positions between an active set and an inactive set of symbol positions for a subsequent stage, and the active set of symbol positions is selectively populated with award values accumulated through the subsequent stage. Additional or alternative stages may be incorporated within the game feature, thereby providing other suitable enhancements, limitations, and the like to the game feature. At least a portion of the stages include value-bearing symbols, which includes award indicia that visually indicate a corresponding award value (and/or other suitable awards). The value-bearing symbols may be used to provide various functionality within the game feature, such as the accumulation of award values and/or trigger different stages.

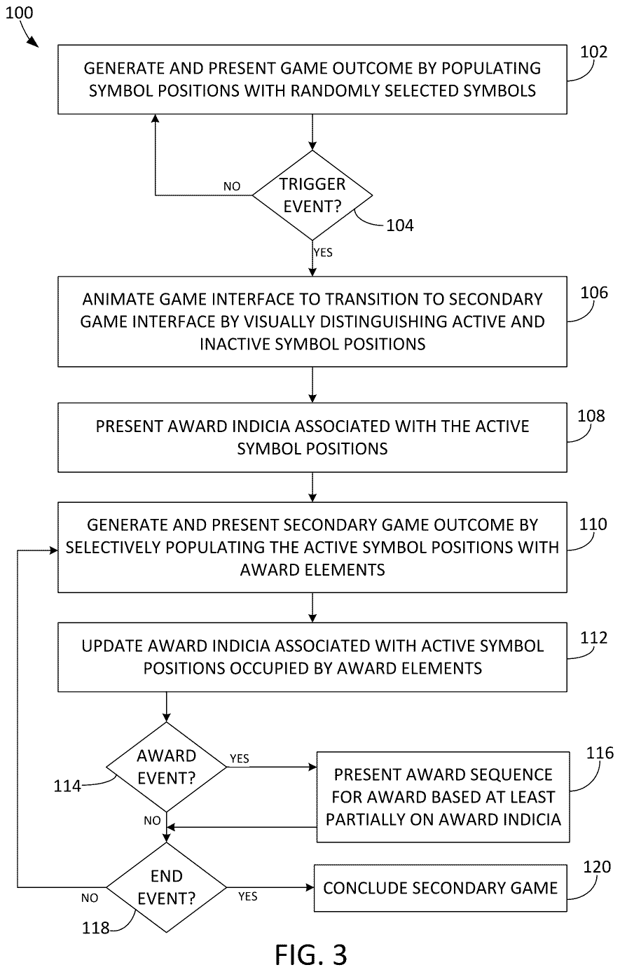

FIG. 3 depicts a flow diagram of an example method 100 for operating a gaming machine of a gaming system (e.g., the machine 10 and system of FIGS. 1 and 2). The method 100 is performed via game-logic circuitry of the gaming system and a presentation assembly of the gaming machine. The game-logic circuitry may be separate from or at least partially integrated with the gaming machine. That is, the method 100 may be performed within various thick or thin client configurations of the gaming machine. In other embodiments, the method 100 is performed by an alternative configuration of devices and/or the method 100 includes additional, fewer, or alternative steps, including those described elsewhere herein.

The method 100 is associated with a game feature of a game provided and presented by the gaming machine. The gaming machine is configured to facilitate play of the game through gaming sessions established by players at the gaming machine. The gaming session is established by the player providing one or more inputs at the gaming machine, either directly (i.e., through providing physical items or direct input to the gaming machine) or indirectly, such as communicating via a personal computing device (e.g., a smartphone) with the gaming machine or other device associated with the gaming system. The player input may, in some embodiments, identify the player, link the gaming session to an account associated with the player, and/or provide a credit input for the game. In embodiments in which the game is a wagering game, the credit input may be used to establish a credit balance. For example, the player may provide one or more physical items representing a credit value (e.g., coins, bills, tickets, cards, etc.) at a corresponding credit input device of the gaming machine, and the sensors of the credit input device detect the value of the credit input to establish the credit balance for funding wagers and accumulating awards. For non-wagering games, the player input may still be a credit input to establish a non-wagering balance (e.g., a period of time, number of outcomes, etc.) or another suitable input.

The presentation assembly is configured to present one or more game interfaces associated with the game in response to initiating the gaming session. The game associated with the method 100 includes one or more game features. In one example, the game includes a base game feature and a bonus game feature. The base game feature is a default game feature, and the bonus game feature is a game feature accessible through one or more trigger events, which may occur in other game features of the game (e.g., the base game feature). The method 100 may be associated with a single game feature (e.g., the base or bonus game feature), or the method 100 may be associated with a plurality of game features within the game. That is, the steps of the method 100 as described herein may occur over a plurality of game features.

At least one of the game interfaces presented by the presentation assembly and associated with the method 100 includes a plurality of symbol positions. The symbol positions are visual spaces or elements that can be occupied by symbols, watermarks, indicia, and/or the like to facilitate the features described herein and other suitable game functionality, such as gameplay functions separate from and/or additional to the functionality described herein. The symbol positions may be arranged into one or more symbol arrays having one or more rows and columns of symbol positions.

The method 100 begins at step 102 with the game-logic circuitry generating a game outcome and causing the presentation assembly to present an outcome sequence visually depicting the game outcome. The game-logic circuitry uses one or more random values or other random determinations (e.g., one or more random values produced by the random number generator of the game-logic circuitry) to randomly select symbols to populate the symbol positions. The symbols are provided in one or more sets of available symbols stored or otherwise accessible by the game-logic circuitry. In some embodiments, each set of available symbols is a symbol-bearing reel strip. Each reel strip may be associated with one or more symbol positions such that symbols of the reel strip are presented within the associated symbol positions. In one example, each column of a symbol array is associated with a respective reel strip. In another example, each symbol position is associated with a respective reel strip. In other embodiments, the available sets of symbols are provided in suitable configurations other than reel strips.

The symbols and/or reel stop positions (i.e., the position at which a reel strip is stopped, thereby exposing one or more symbols in the associated symbol positions) may be stored in one or more weighted tables. The weighted tables use weight parameters to adjust relative probabilities of selecting symbols for game outcomes. In one example, the weight parameters define one or more values associated with each symbol or reel stop position, and a random value generated by the game-logic circuitry is compared to these predefined values to select a symbol or reel stop position for a given game outcome. In certain embodiments, additional or alternative game elements and/or game events may be selected or determined through the weighted tables stored by the game-logic circuitry.

The presentation assembly is configured to present the outcome sequence for the game outcome via one or more animations, audiovisual updates, and the like to visually convey to the player what symbols form the game outcome. It is to be understood that populating the symbol positions with randomly selected symbols may include populating one or more symbol positions with a “blank” (i.e., an empty symbol position) or an inactive symbol, where the inactive symbol is not considered within the game outcome and may be visually distinct from active symbols that are considered for the game outcome. In one example, the outcome sequence includes spinning and stopping animations for the symbol-bearing reel strips, where the symbols occupying the symbol positions with the stopped reel strips form the game outcome. Other suitable animations, such as animations visually updating one or more meters for tracking credit balances, awards, and the like, may be incorporated within the outcome sequence.

In response to generating the game outcome, the game-logic circuitry stores one or more parameters, rules, and/or processes for generating one or more outcome determinations. The outcome determinations are determinations performed at least partially based on the symbols, game events, and/or other aspects of the current game state. For example, the game-logic circuitry performs one or more outcome determinations to identify any winning symbol combinations based on predefined parameters and the symbols currently occupying the symbol positions for a given game outcome. In another example, for a limited duration game feature (or other duration-based game event or condition), the game-logic circuitry determines whether the limited duration game feature has concluded in response to the game outcome.

In the example embodiment, at step 104, the game-logic circuitry performs an outcome determination to determine whether a trigger event for a secondary game feature has occurred based on the game outcome. The secondary game feature may be a bonus game feature such that the game outcome at step 102 occurs within the base game feature, or a secondary stage of a multistage game feature incorporating the step 102. The trigger event may include, for example and without limitation, one or more trigger symbols occupying the symbol positions, a trigger combination of symbols within the symbol positions, a particular trigger from or at least partially based on a game element external to the symbol positions (e.g., a wheel or prize board), a wager event, random chance, and the like. In one example, the game-logic circuitry analyzes the symbols of the game outcome to determine whether or not a threshold number of trigger symbols are present within the game outcome. In another example, an outcome counter is updated in response to each game outcome (or each game outcome satisfying certain parameters) at step 102, and the trigger event is detected in response to the counter reaching a threshold value, such as zero.

In at least some embodiments, the trigger symbols are value-bearing symbols that, when presented by the presentation assembly, have award indicia for visually indicating a corresponding award value and/or other suitable award, such as a multiplier, free spins or game outcomes, and the like. In certain embodiments, the trigger symbols may be revealed as or converted to value-bearing symbols in response to the trigger event. In some embodiments, the trigger symbols may be held within the symbol positions during the initial stage or game feature associated with the steps 102 and 104 for a plurality of game outcomes such that the threshold number of trigger symbols to activate the trigger event may be accumulated over a plurality of game outcomes. In other embodiments, the trigger symbols are not held within the symbol positions, which may require the trigger symbols to meet the threshold number within a single game outcome. In certain embodiments, the trigger symbols and/or other trigger parameters may be accumulated through additional or alternative means and/or presentations, such as a counter external to the symbol positions that counts each trigger symbol over a plurality of game outcomes or a border or watermark held within a corresponding symbol position. In embodiments in which trigger symbols are held, counted, or otherwise accumulated over a plurality of game outcomes, the method 100 may include one or more additional outcome determinations for clearing or resetting the accumulated trigger symbols. In one example, the held trigger symbols may be held for three subsequent game outcomes before removal.

At step 104, if the game-logic circuitry does not detect a trigger event, the game-logic circuitry performs any remaining outcome determinations before awaiting a subsequent game outcome at step 102. However, if the game-logic circuitry detects the trigger event, the method 100 proceeds to the secondary game feature. At step 106, the presentation assembly animates the game interface to transition from a primary game interface to a secondary game interface associated with the secondary game feature. In at least some embodiments, the secondary game interface may include many of the same or similar game and/or presentation elements as the primary game interface, or the game and/or presentation elements are adapted to the specific theme and configuration of the secondary game interface. The secondary game feature includes dividing the symbol positions into at least two different sets: a set of active symbol positions, and a set of inactive symbol positions. In some embodiments, additional sets of symbol positions, including at least partially overlapping sets, may be used according to the specific configuration, theme, and functionality of the secondary game feature. In the example embodiment, the division of the symbol positions from the primary game interface is based on whether or not a given symbol position was occupied by a trigger symbol. In other embodiments, other suitable parameters may be used to divide the symbol positions between active and inactive symbol positions, such as a linked visual characteristic between symbols or symbol positions and/or user input. In certain embodiments, the active and inactive symbol positions may be at least partially based on one or more random determinations or values. It is to be understood that although the secondary game feature may require at least one active symbol position for the functionality described herein, the secondary game feature may be initiated without any inactive symbol positions based on the trigger event. For example, if every symbol position is occupied by a trigger symbol or a special trigger symbol is detected, then every symbol position may be determined to be active for the secondary game feature.

The presentation assembly is configured to visually distinguish between the active and inactive symbol positions. For example, the inactive symbol positions may be greyed out, partially transparent, or otherwise visually diminished relative to the presentation of the active symbol positions. In one example, the presentation assembly visually distinguishes between active and inactive symbol positions through perceived depth of the positions, where active symbol positions appear to be closer to the player while the inactive symbol positions appear to be further from the player. In some embodiments, the inactive symbol positions are removed or hidden from the secondary game interface. In other embodiments, the symbol positions may be reorganized within the secondary game interface into groups of active or inactive symbol positions. For example, the active symbol positions may be reorganized together into a smaller symbol array or towards the bottom, top, right, or left of the symbol array.

In some embodiments, the secondary game interface includes one or more additional changes relative to the primary game interface. For example, and without limitation, the secondary game interface may include new game and/or presentation elements, visually update game and/or presentation elements from the primary game interface (including rearranging the existing elements within the interface), and the like.

At step 108, the presentation assembly is configured to present award indicia associated with one or more of the active symbol positions. The award indicia may be used to monitor accumulated awards from the secondary game feature as described herein. In some embodiments, the award indicia may be presented as value-bearing symbols presented within the active symbol positions. In at least some embodiments with value-bearing trigger symbols, the trigger symbols may remain within the active symbol positions for presenting the award indicia. In other embodiments, the award indicia may be presented through other suitable configurations that enable a player to clearly monitor the awards accumulated through the secondary game feature. In one example, the award indicia are presented as watermarks, backgrounds, or other graphical aspect of a given active symbol position. In another example, a counter—which may be at least partially overlapping the associated symbol position or wholly external to the associated symbol position—is presented to visually monitor a corresponding award value. In certain embodiments, a global counter or meter is used to visually monitor all awards accumulated through the secondary game feature.

In some embodiments, the award indicia of one or more active symbol positions may not be initially presented, particularly for active symbol positions associated with an award value of zero. In certain embodiments, zero-value award indicia may include an alternative presentation relative to a numeral-based indicia used for non-zero award indicia, such as a presentation incorporating animations and/or other graphical elements. The hidden or otherwise obscured award indicia is revealed in response to one or more trigger events, such as accumulating a non-zero award value or triggering an award sequence associated with the award indicia.

At step 110, the game-logic circuitry generates a secondary game outcome and causes the presentation assembly to present the secondary game outcome. More specifically, the game-logic circuitry randomly selects award elements and/or blanks to populate the active symbol positions. The “award elements” are symbols, indicia, and/or other suitable game elements that selectively occupy the active symbol positions within the secondary game feature. For example, the award elements may be value-bearing symbols, modifier symbols, jackpot symbols, free spins symbols, award indicia, modifier indicia, and the like. In some embodiments, the active symbol positions may be populated with symbols or game elements other than award elements or blanks to facilitate additional game functionality, which may include game functionality that adjusts, enhances, or otherwise affects the game functions associated with the method 100. In one example, scatter pays may be available in the secondary game feature, and the active symbol positions are selective populated with standard array-based symbols for generating winning symbol combinations.

The inactive symbol positions, for embodiments in which the inactive symbol positions remain within the secondary game interface, may be populated with inactive symbols during the secondary game outcome or remain unpopulated for the duration of the secondary game outcome. In certain embodiments, the inactive symbol positions may be selectively activated during the secondary game feature in response to one or more activation triggers. In one example, the inactive symbol positions may be selectively populated with an activation symbol to initiate the position activation. The activation symbol may also be a trigger symbol for the trigger event at step 104, such as a value-bearing trigger symbol. In another example, a game event or condition detected at least partially based on symbols occupying the active symbol positions causes one or more inactive symbol positions to be activated. In a further example, one or more random determinations trigger the position activation and/or one or more inactive positions are activated in response to a predefined sequence (e.g., activating an additional symbol position for each subsequent secondary game outcome).

In response to generating the secondary game outcome, the game-logic circuitry performs one or more outcome determinations associated with the secondary game feature. In the example embodiment, at step 112, the game-logic circuitry is configured to detect any award elements within the active symbol positions and cause the presentation assembly to update award indicia associated with the occupied active symbol positions at least partially as a function of the corresponding award elements. In some embodiments, the award element may include award indicia, and the presentation assembly is configured to update the award indicia of the active symbol position at least partially as a function of the award indicia of the award element. In one example, the award value of the award element is accumulated with the current value associated with the active symbol position. In another example, if the award value of the award element is greater than the current award value associated with the active symbol position, the current award value is replaced by the award value of the award element. Additional or alternative mathematical and/or logical operations may be used to update the award value of the occupied active symbol positions, including operations that may selectively result in the award value of the symbol positions remaining unchanged.

In the example embodiment, the award values associated with the active symbol positions and visually indicated by the award indicia may not be immediately and directly awarded in response to any award value updates at step 112. Rather, the award values are configured to be held or maintained for the active symbol positions for one or more secondary game outcomes until the values are awarded or removed as described herein. In certain embodiments, the held award values may by updated in response to each subsequent secondary game outcome. For example, the held award values may increase or decrease in response to each subsequent secondary game outcome, or at least each secondary game outcome in which the award value is not updated in response to an award element. At step 114, the game-logic circuitry performs an outcome determination to determine whether or not an award event has occurred. In one example, the award event may be an event and/or condition resulting in the end or conclusion of the secondary game, such as a secondary game counter for monitoring a duration of the secondary game feature reaching a termination count. In another example, the award event includes a catalyst symbol, catalyst symbol combination, and/or other catalyst event detected from the secondary game outcome. In other embodiments, the award event includes detecting the award elements and updated award indicia at step 112 such the updated award values are awarded as described herein.

If an award event is detected at step 114, the game-logic circuitry proceeds to step 116 and causes the presentation assembly to present an award sequence for an award based at least partially on the award indicia of one or more active symbol positions. In one example, the award is an aggregated award that is a function of the award values of one or more active symbol positions associated with the award event (which may include all of the active symbol positions). In another example, the greatest award value(s) are selected from the active symbol positions and provided as the award. Other suitable mathematical and/or logical operations may be used to determine the award associated with the award sequence, including operations to determine which active symbol positions are associated with the award event. In some embodiments, all of the active symbol positions are associated with the award. In other embodiments, a subset of the active symbol positions (including subsets of one symbol position) is associated with a given award. In such embodiments, the associated symbol positions may be determined based on the award event (e.g., the location of a catalyst symbol or symbol combination, etc.). In certain embodiments, the subset of active symbol positions may be selected at least partially at random via one or more random values generated by the game-logic circuitry.

The award sequence presented by the presentation assembly includes one or more animations and/or other visual updates to visually convey to the player the award and, in at least some embodiments, the underlying game elements associated with the award. For example, if the award is an aggregated award, an award and/or credit meter is updated, and the award indicia of the active symbol positions are removed in response to each award of the corresponding active symbol positions being applied to the aggregated award. Other suitable award sequences may be used to facilitate different configurations and/or themes of the game and the secondary game feature.

Following the step 116 or in response to determining no award event is present at step 114, the game-logic circuitry continues performing any remaining outcome determinations for the secondary game outcome. At step 118, the game-logic circuitry performs another outcome determination to detect whether or not an end or termination event has occurred for the secondary game feature. That is, the end or termination event includes one or more game events and/or conditions that cause the secondary game feature to conclude and return to the primary game feature or other suitable game feature. For example, and without limitation, the end event may include detecting an expired duration counter for the secondary game feature, detecting the presence of one or more end or termination symbols, detecting the absence of one or more symbols and/or other game elements that extend the duration, and/or the like.

If an end or termination event is detected, the game-logic circuitry proceeds to step 120 and concludes the secondary game feature. Concluding the secondary game feature includes presenting, via the presentation assembly, one or more transition sequences to transition the game interface from the secondary game interface to the game interface of a subsequent game feature, such as the primary game feature or other suitable game feature. The transition sequence may include, for example, reverting the symbol positions from the active and inactive symbol positions to a single, unified set of symbol positions. If the end or termination event is not detected, the secondary game feature continues. More specifically, a subsequent secondary game outcome is generated at step 110, and steps 112-120 are repeated until the end event is detected or the player initiates a payout sequence to conclude the gaming session.

In some embodiments, the award event and the end event may be the same event, or the end event is active in response to the award event. In such embodiments, the steps 114 and 118 may be performed together and steps 116 and 120 may be performed in response to the detecting the award and end event.

FIG. 4 depicts an example game interface 200 of a gaming system for one or more game features, such as the game features associated with the method 100 shown in FIG. 3. The game interface 200 is presented by a presentation assembly of a gaming machine within the gaming system, such as the gaming machine 10 shown in FIGS. 1 and 2. The presentation assembly is in communication with game-logic circuitry to perform the functionality described herein with respect to the interface 200. The interface 200 includes a symbol array 202, an award meter 204, a bet or wager meter 206, an award meter 208, and a duration counter 210. In other embodiments, the interface 200 includes additional, fewer, or alternative game and/or presentation elements, including those described elsewhere herein.

The symbol array 202 includes a plurality of symbol positions arranged into one or more rows and columns. In the illustrated embodiment, the array 202 includes five rows and five columns of symbol positions. In other embodiments, the array 202 may include a different configuration of symbol positions, including configurations with additional or fewer symbol positions. In certain embodiments, the game interface 200 includes a plurality of symbol arrays 202.

The symbol array 202 is selectively populated with randomly selected symbols for each game outcome of the game feature associated with the game interface 200. In some embodiments, the randomly selected symbols are included within one or more symbol-bearing reel strips that are animated to spin and stop to visually depict the symbols forming the game outcome. Each reel strip is associated with one or more symbol positions such that a respective symbol from the reel strip is shown in each associated symbol position when the reel strip has been animated to stop spinning. The symbols occupying the symbol array 202 for a given game outcome may include several different types of symbols having similar or different functionalities. In the illustrated state, the symbol array 202 includes various standard array-based symbols and a plurality of value-bearing symbols 212. Each value-bearing symbol 212 includes award indicia within for visually indicating a respective award value. The value-bearing symbols 212 may include additional or alternative award indicia and/or other suitable graphical elements to visually convey the corresponding award value.

The meters 204, 206, 208 provide visual elements for indicating different aspects of the game, particularly in response to game events deriving from a given game outcome. The credit meter 204 monitors the current credit balance (or other suitable balance for the game, such as a timer for non-wagering game embodiments). The bet or wager meter 206 monitors the current or last wager provided by the player. The award meter 208 depicts the current or last award collected by the player during play of the game. Additional, fewer, or alternative meters may be used in other embodiments to provide different configurations of information and/or graphical presentation elements associated with the gaming session.

In the example embodiment, the game interface 200 is associated with a game feature that has a limited duration function, such as a primary or secondary stage of a multistage game feature. The game interface 200 includes the duration counter 210 to provide a visual indication of the current progress through the limited game duration. In the illustrated embodiment, the duration counter 210 indicates the remaining number of game outcomes, while other embodiments may present other suitable indications of the duration, such as the number of outcomes already concluded. Additionally or alternatively, the duration counter 210 may be presented in other suitable forms to align with the underlying game theme, configuration, and/or presentation scheme, such as a set of graphical elements that visually change or are selectively hidden from the game interface 200 to indicate the remaining duration to the player. In at least some embodiments, the duration of the game feature is dynamic such that the duration is extended or reset in response to one or more corresponding game events of the game feature. In such embodiments, the duration counter 210 is configured to be updated in response to these reset or extension game events.

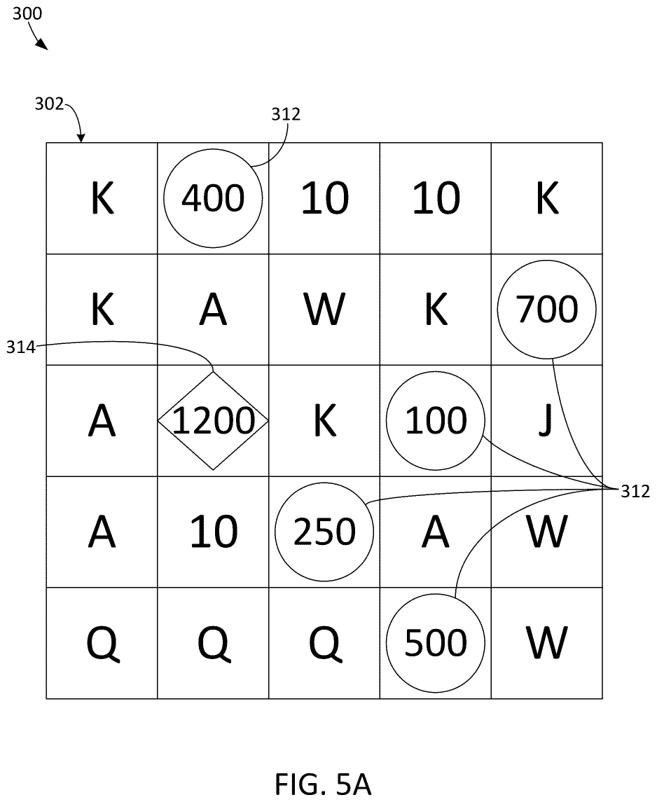

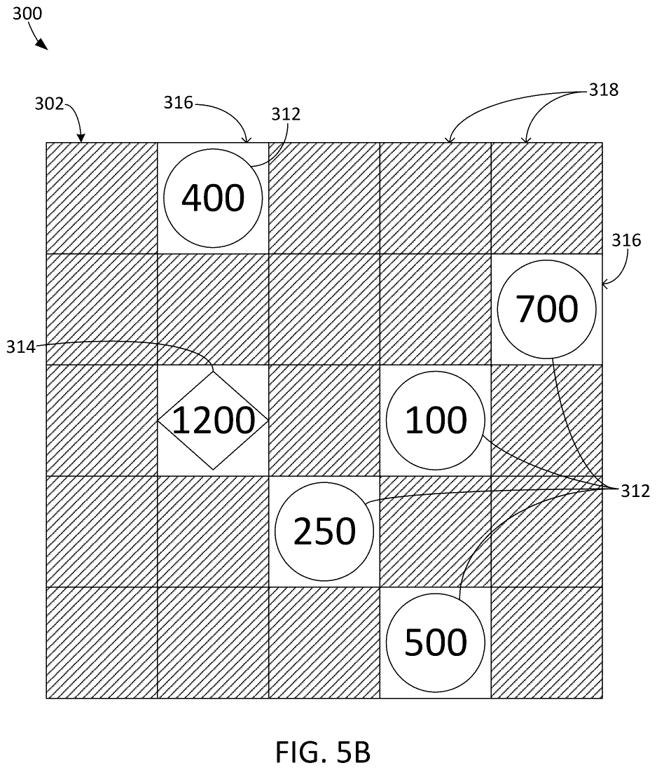

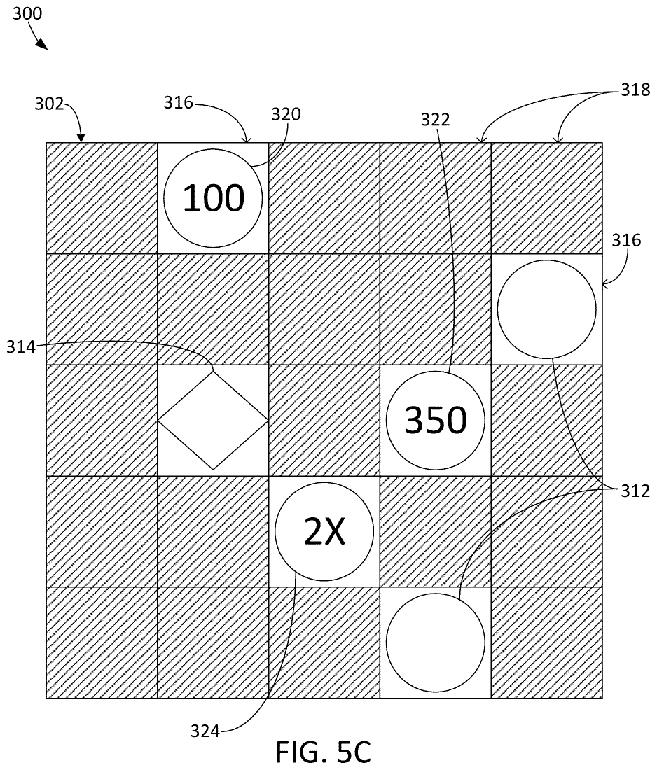

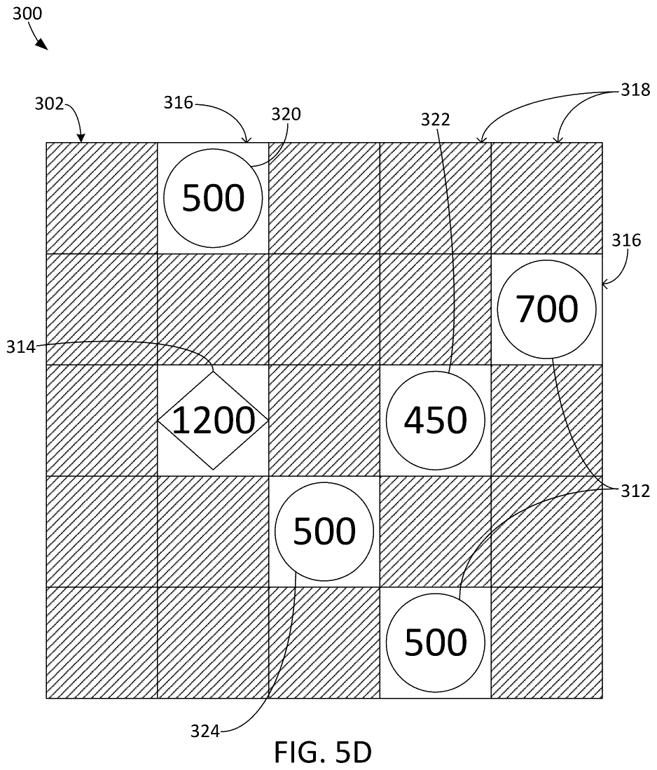

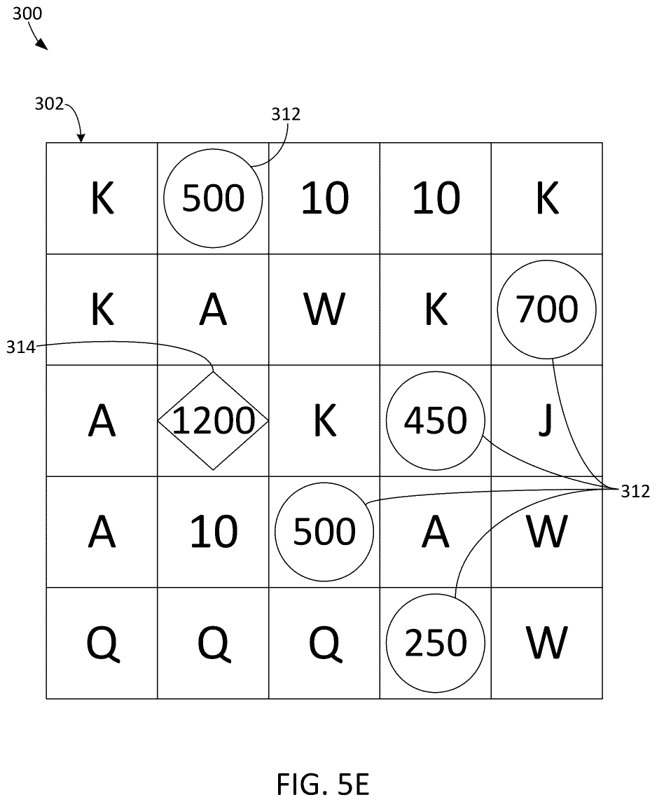

FIGS. 5A-5E depict an example game interface 300 for display by a presentation assembly of a gaming system in several example game states. More specifically, the game interface 300 is presented by a presentation assembly of a gaming machine of the gaming system (e.g., the system and machine 10 of FIGS. 1 and 2). The presentation assembly is in communication with game-logic circuitry of the gaming system to the functionalities described herein with respect to the different game states and changes therebetween. The game-logic circuitry may be at least partially integrated with the gaming machine or wholly separate and in communication with logic circuitry of the gaming machine to provide game functionality. The game associated with the game interface 300 is conducted at the gaming machine and includes a multistage game feature (or several linked game features) as described herein.

In the example embodiment, the game interface 300 includes a symbol array 302 formed by a plurality of symbol positions arranged into rows and columns. More specifically, the symbol array 302 includes twenty-five symbol positions arranged into five rows and five columns. The symbol array 302 may include a different number of symbol positions and/or have the symbol positions arranged into a different configuration, including configurations that result in a non-uniform array 302. In other embodiments, the game interface 300 includes additional, fewer, or alternative game and/or presentation elements, including those described elsewhere herein. For example, the meters 204, 206, 208 from the game interface 200 of FIG. 4 may be incorporated into the game interface 300.

With respect to FIG. 5A, the game interface 300 is depicted in a first state. In the first state, a game outcome is presented for a primary game feature or game stage, and the game outcome includes a trigger event for a secondary game feature. The underlying game or gaming session associated with the game interface 300 includes a plurality of game features, which may also be referred to as game “stages.” At least two of the game features, a primary game feature and a secondary game feature, are linked to each other such that certain game events and/or conditions from the primary game feature affect the secondary game feature. In some embodiments, the primary game feature is a base or default game feature in which play of the game is played until a particular trigger event occurs and, upon expiration of any initiated game features, play of the game returns until the player associated with the gaming session initiates a payout sequence. In other embodiments, the primary and secondary game features are bonus or special game features that are initiated from a different base game feature. In such embodiments, the primary game feature may always be initiated in response to a corresponding bonus trigger event from the base game feature, and the secondary game feature may be either guaranteed to trigger within or following the primary game feature or selectively triggered response to trigger events detectable within the primary game feature.

In the example embodiment, the game outcome from the primary game feature includes populating the symbol array 302 with a plurality of randomly selected symbols. In some embodiments, the symbols are presented via symbol-bearing reel strips that are animated to spin and stop in a manner that exposes a symbol (or blank) of the reel strip in each associated symbol position. In other embodiments, other suitable sets of available symbols and/or animations for presenting the randomly selected symbols of the game outcome may be used.

The randomly selected symbols include various types of symbols that are evaluated, alone or in combination with the relative location of each symbol in the array 302, by the game-logic circuitry with respect to stored parameters, rules, and other stored data defining various game events and/or conditions. One such outcome determination includes detecting whether or not any secondary trigger events are present. For example, the secondary trigger event may include detecting a threshold number of trigger symbols in the game outcome (or over a plurality of game outcomes) or detecting a particular trigger or catalyst trigger symbol in the game outcome, either alone or in combination with one or more other linked symbols. In other embodiments, the game outcomes may include additional or alternative game elements for generating game outcomes (e.g., a wheel external to the symbol array 302, watermarks or backgrounds applied to the symbol positions, etc.). In such embodiments, the secondary trigger event determination and other outcome determinations may be at least partially dependent upon the current state of these game elements beyond the symbol array 302.

In the example embodiment, the randomly selected symbols forming the game outcome include a plurality of value-bearing symbols 312 and a catalyst value-bearing symbol 314. In other embodiments, the catalyst value-bearing symbol 314 is substantially similar to the value-bearing symbols 312 described herein without the catalyst functionality described herein. In one example, the value-bearing symbols 312 and the catalyst value-bearing symbol 314 are trigger symbols, where detecting a threshold number of trigger symbols determines the presence of the secondary trigger event. In another example, the catalyst value-bearing symbol 314 alone (or, in some embodiments, in combination with other catalyst trigger symbols) is the trigger symbol for the secondary trigger event. In such an example, each catalyst symbol detected may be an independent secondary trigger event, or excess catalyst symbols may be used to enhance the following secondary game feature (e.g., increased duration, increased awards, etc.). In a further example, the catalyst value-bearing symbol 314 in combination with at least one value-bearing symbol 312 determines the presence of the secondary trigger event. In some embodiments, the trigger symbols or trigger game elements are not limited to value-bearing symbols and may include, for example and without limitation, modifier symbols, wild symbols, jackpot symbols, free spin symbols, enhanced standard symbols, symbols solely for the secondary trigger event, and/or other suitable symbols. The trigger symbols may include distinguishable visual presentations that readily inform the player that the trigger symbols have a linked game functionality. In embodiments with non-value-bearing trigger symbols, the secondary game feature may be adjusted or adapted to accommodate the other types of trigger symbols, including replacing the trigger symbols with value-bearing symbols.

If no secondary trigger event is detected, the game-logic circuitry continues the primary game feature. In some embodiments, the trigger symbols may be held within the symbol array 302 for one or more subsequent primary game outcomes. If the game-logic circuitry does detect the secondary trigger event from the game outcome, the game-logic circuitry initiates the secondary game feature. In certain embodiments and as described in detail herein, the game-logic circuitry may store within one or more data structures the current state of the primary game feature to facilitate resuming the primary game feature after the secondary game feature and/or to enhance the primary game feature based on events, awards, actions, and the like taken through the secondary game feature.

The presentation assembly is configured to transition the game interface 300 from the primary game feature to the secondary game feature. That is, one or more game and/or presentation elements may be different from the game interface 300 between the primary and secondary game features, and the presentation assembly is configured to visually update the interface 300 to present the new and/or altered elements of the secondary game interface. The transition may be visually depicted through a transition sequence including one or more animations that visually indicate to the player that a new game feature is being initiated. In certain embodiments, the transition sequence includes animations and/or presentation elements to highlight the secondary trigger event and/or other suitable changes occurring for play of the secondary game feature, including those described herein.

FIG. 5B depicts the game interface 300 in a second state following the first state. The second state is shown during a transition sequence from the primary game feature to the secondary game feature following the secondary trigger event in the first state. More specifically, the secondary game feature is configured to use a subset of the symbol positions from the primary game feature based at least partially on the secondary trigger event. That is, a portion of the symbol positions forming the symbol array 302 in the first state are designated as active symbol positions for the secondary game feature while another portion of the symbol positions are designated as inactive positions or are otherwise removed from the game interface 300 for the secondary game feature. In other embodiments, additional or alternative subsets of symbol positions may be designated, and/or additional symbol positions beyond those found in the symbol array 302 during the first state may be added during the transition to the secondary game feature. In one example, a third subset of symbol positions are defined as selectively activatable symbol positions, where the symbol positions may become active symbol positions through game events occurring in the secondary game feature.

In the example embodiment, the game-logic circuitry identifies the active symbol positions based on the trigger, value-bearing, and/or other suitable symbols in the symbol array in the first state. That is, the symbol positions occupied by the value-bearing symbols 312 and the catalyst value-bearing symbol 314 are selected to be active symbol positions for the secondary game feature. Based on the selection, the symbol positions of the symbol array 302 are divided into a set of active symbol positions 316 and a set of inactive symbol positions 318. In other embodiments, the selection of active and inactive symbol positions 316, 318 may be at least partially based on one or more additional or alternative parameters. In one example, at least one active symbol position is selected based on one or more random determinations by the game-logic circuitry. In another example, the number of trigger symbols for the secondary trigger event may be used to functionally determine whether or not one or more additional symbol positions are to be selected as active for the secondary game feature. That is, the game-logic circuitry stores one or more threshold values that, when met or exceeded by the number of trigger symbols detected, causes the game-logic circuitry to select one or more additional symbol positions beyond those occupied by the trigger symbols to be active. In such embodiments including active symbol positions 316 that are not otherwise occupied a trigger symbol or symbol suitable for the game functionality described herein with respect to the secondary game feature, a value-bearing symbol or other suitable symbol (e.g., a modifier symbol) may be added to these active symbol positions 316, either at the beginning of the secondary game feature or in response to certain game events described herein.

The presentation assembly is configured to present the active symbol positions 316 and the inactive symbol positions 318 in a visually distinguishable manner relative to each other. For example, and without limitation, the active symbol positions 316 may be highlighted, enlarged, or moved within the game interface 300 to a central position for player focus; and/or the inactive symbol positions 318 may be greyed out, at least partially transparent, moved away from player focus within the interface 300, or altogether removed from the interface 300. In other embodiments with additional or alternative sets of symbol positions, other suitable visual characteristics may be applied to one or more subsets to visually distinguish which subset includes each symbol position.

In the second state, the award values from the first state are retained by the value-bearing symbols 312, 314 as award indicia within the presentation of the interface 300. In the embodiments described herein, the value-bearing symbols 312, 314 are used to visually indicate new award values from subsequent secondary game outcomes, and the initial award indicia may be hidden or removed through the secondary game outcomes. In some embodiments, the award values of the value-bearing symbols 312, 314 are stored and combined with the new award values from the secondary game feature. In such embodiments, the award indicia may be updated throughout the secondary game feature to visually indicate the current award value of each value-bearing symbol 312, 314 after each secondary game outcome, or other suitable presentation elements may be used to visually track and monitor accumulated awards (e.g., a meter, similar to the award meter 208 shown in FIG. 4). In other embodiments, the award values of the value-bearing symbols 312, 314 from the primary game feature are not carried into the secondary game feature, and the new awards from the secondary game feature are accumulated isolated from the award values from the first state. In such embodiments, the trigger award values from the first state may be awarded in an award sequence included within the transition sequence between the first and second states, or the game-logic circuitry is configured to “snapshot” the trigger game state (i.e., the first state) or store the game state to memory such that the primary game feature can be resumed from the first state following the conclusion of the secondary game feature.

FIG. 5C depicts the game interface 300 in a third state following the second state. In the third state, a secondary game outcome is shown. In particular, the game-logic circuitry is configured to generate a secondary game outcome by randomly selecting one or more award values and/or other suitable game elements to populate the active symbol positions 316, and the presentation assembly is configured to present a secondary outcome sequence to visually present the secondary game outcome. The secondary game outcome may be initiated in response to a wager from the player, or the secondary game feature may be a bonus or “free spins” game feature. The award values and/or other game elements are selected from one or more sets of available awards, which may include one or more blanks (i.e., no award, illustrated as empty symbols in the third state). The sets of available awards may include predefined values, or the values may be generated at least partially as a function of a selected award parameter. In one example, the game-logic circuitry selects an award parameter identifying a tier or relative value of the award, and the game-logic circuitry randomly generates an award value within the identified tier for the secondary game outcome. In another example, the award values are generated at least partially as a function of the wager of the player, the wager either being for the current outcome or the trigger outcome from the primary game feature in the first state.

The presentation assembly is configured to present a secondary outcome sequence that visually animates the game interface 300 to convey to the player that a selection has been generated and finalized. In the illustrated embodiment, the award indicia of the value-bearing symbols 312, 314 are used to visually indicate any new awards from the secondary game outcome. In such embodiments, available awards may be spun or otherwise cycled through the award indicia of the active symbol positions before stopping on the awards and/or blanks forming the secondary game outcome. In other embodiments, other suitable animations and/or visual updates may be used to convey the secondary outcome sequence. In the example embodiment, the inactive symbol positions 318 are not populated during the secondary game feature. In other embodiments, the inactive symbol positions 318 are populated with inactive symbols or awards that do not impact the secondary game outcome. In certain embodiments, the inactive symbol positions 318 are selectively populated with activation symbols or awards that convert the associated inactive symbol positions 318 into active symbol positions 316 for one or more secondary game outcomes (e.g., until the conclusion of the secondary game feature).

In the example embodiment, the award indicia visually convey any new awards from the secondary game outcome, and the prior award indicia has been at least temporarily hidden from the game interface 300. In other embodiments, the award indicia may be presented through other suitable presentation elements for each of the value-bearing symbols 312, 314, such as one or more meters external to the symbol array 302 or additional award indicia or watermarks associated with each active symbol position 316.

In the third state, two value-bearing symbols 312 have been occupied by blanks in addition to the catalyst value-bearing symbol 314. In some embodiments, the catalyst value-bearing symbol 314 must be occupied or otherwise active to collect awards within other active symbol positions 316. Additionally, three of the value-bearing symbols 312 include new awards. More specifically, value-bearing symbols 320, 322 include new credit awards, and a third value-bearing symbol 324 includes a multiplier. The new awards are applied to any existing award value associated with each of the value-bearing symbols 320, 322, 324. That is, the credit award values of the value-bearing symbols 320, 322 are aggregated with the prior award value (shown in FIG. 5B), and the multiplier of the value-bearing symbol 324 is applied to the respective prior award value. In other embodiments, the new awards may be applied in other suitable mathematical and/or logical operations. In one example, any new credit awards are compared to the corresponding prior award values, and the award value with the greater value is retained. In another example, any multiplier is held until the conclusion of the secondary game feature before being applied such that any subsequent award values are accumulated first before the multiplier is applied. For new awards occupying active symbol positions 316 that did not have a prior award value, a new value-bearing symbol may be presented within these positions to present award indicia.

FIG. 5D depicts the game interface 300 in a fourth state following the third state. In the fourth state, the award indicia of the value-bearing symbols 312, 314 have been updated to reflect the new awards from the secondary game outcome in the third state. More specifically, the value-bearing symbols 312, 314 occupied by blanks have the same values, while the value-bearing symbols 320, 322, 324 have been updated to reflect the combination of award values shown in FIGS. 5B and 5C. More specifically, the value-bearing symbols 320, 322 reflect an aggregation of the two values from FIGS. 5B and 5C, while the multiplier from FIG. 5C is applied to the value shown in FIG. 5B for the value-bearing symbol 324.

In some embodiments, the active symbol positions 316 may be populated with other suitable award elements or symbols. For example, jackpot symbols or jackpot indicia may cause a corresponding jackpot award to be applied to the award indicia. In another example, an aggregation symbol or indica aggregates or collects value from other award indicia before being applied to the underlying award indicia of the active symbol position 316. In a further example, extension indicia increases the duration of the secondary game feature.

The secondary game feature may continue for one or more subsequent secondary game outcomes similar to the progression of states shown in FIGS. 5B-5D, or the secondary game feature may conclude after a single secondary game outcome. The game-logic circuitry determines the conclusion of the secondary game feature through one or more outcome determinations following a secondary game outcome. In one example, the secondary game feature has a limited duration, either a static or dynamic duration, and the game-logic circuitry stores one or more variables monitoring the remaining duration of the secondary game feature, such as a duration counter. If the duration counter has reached a termination threshold (or other suitable variables representing potential termination conditions indicate a termination event has occurred), the game-logic circuitry causes the secondary game feature to conclude, thereby returning the gaming session to the primary game feature or another suitable game feature. The presentation assembly may be configured to present one or more graphical elements that indicate to the player the remaining duration of the secondary game feature.

In response to detecting a termination condition, the presentation assembly is configured to present a transition sequence to transition the game interface 300 from being a secondary game interface back to the primary game interface of FIG. 5A or another suitable game interface. In some embodiments, the conclusion of the secondary game feature automatically triggers an award associated with the award values indicated by the award indicia at the end of the secondary game feature. In such embodiments, the transition sequence includes an award sequence for the award. The award may be an aggregate award of each and every award shown in the active symbol positions 316, or the award may be associated with one or more of the active symbol positions 316. The awards associated with a subset of the active symbol positions 316 may be determined based at least partially on random chance, player selection, a predefined maximum number of selected active symbol positions 316, the number of awards above a certain threshold value, and/or other suitable parameters. In other embodiments, the award may be functionally derived through additional or alternative mathematical and/or logical operations.

For embodiments with an award sequence, the award indicia and/or the symbols within the active symbol positions may be removed via one or more animations and/or visual updates to the game interface 300 to visually indicate that the awards have been accumulated and awarded. In some embodiments, the conclusion of the secondary game feature does not include an automatic award, but rather the values accumulated through the secondary game feature are carried back into the primary game feature to be used and/or awarded within the primary game feature.

FIG. 5E depicts the game interface 300 in a fifth state following the fourth state. Between the fourth and fifth states, the game interface 300 has undergone a transition sequence, which has caused the divided symbol positions of the symbol array 302 to return to a unified presentation (i.e., the presentation of the primary game interface shown in FIG. 5A). In the example embodiment, the game-logic circuitry has stored or otherwise maintained a snapshot of the game state at the secondary trigger event from the first state (shown in FIG. 5A), and the symbols other than the value-bearing symbols 312, 314 have been returned to the array 302 (or, in some embodiments, the symbols remain in the inactive positions 318). While the positions of the value-bearing symbols 312, 314 have been maintained, the values indicated by the value-bearing symbols 312, 314 include the final values from the secondary game feature. In some embodiments, the value-bearing symbols 312, 314 may be held in the symbol array 302 for one or more primary game outcomes until a removal condition or award condition is met. The removal condition (e.g., expiration of a limited duration) may cause the held symbols to be removed from the array 302. The award condition (e.g., detecting an award symbol or combination of symbols, the primary game feature concluding) may cause the held award values to be awarded. In certain embodiments, the transition sequence both includes an award sequence based on the held award indicia at the conclusion of the secondary game feature and maintains the current state of the held value-bearing symbols into the primary game feature.

In one example, the primary game feature has a limited duration and is configured to hold value-bearing symbols and/or other suitable symbols within the symbol array 302. Each primary game outcome reduces the remaining duration of the primary game feature. Triggering the secondary game feature from a primary game outcome suspends the duration of the primary game feature while the secondary game feature is conducted. For each new primary game outcome, a new instance of the secondary game feature may be triggered through a new secondary trigger event, thereby providing additional opportunities to enhance existing awards via unique presentation sequences. The unique configuration of the gaming system relies about reduced game elements (i.e., active symbol positions) and readily understood indicia without introducing complex, resource-heavy analysis of the game outcomes that limit the computing resources of the gaming system from being provided to other aspects of the gaming session, such as other game mechanics, accounting services, player services, and the like. These benefits are not limited to the example above, but rather are applicable to additional embodiments of the present disclosure, including those described elsewhere herein.

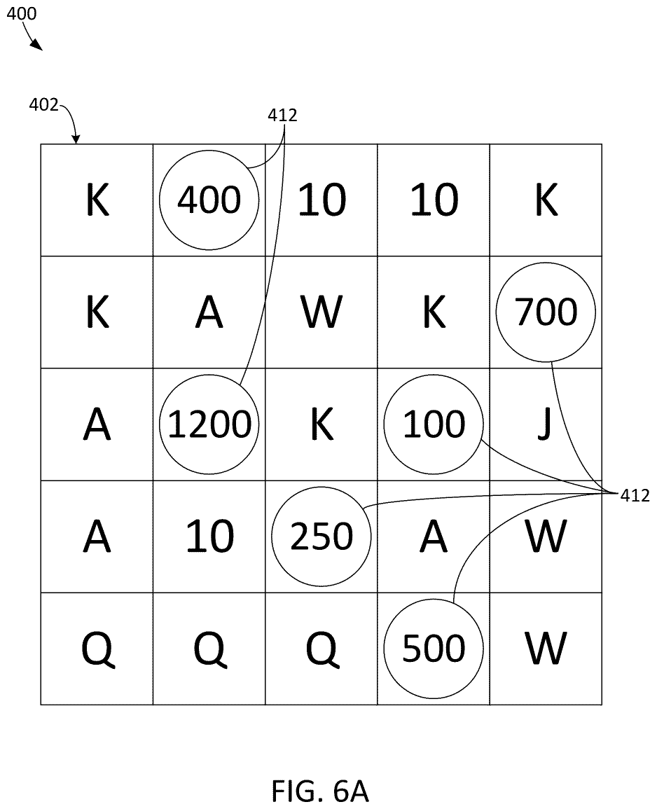

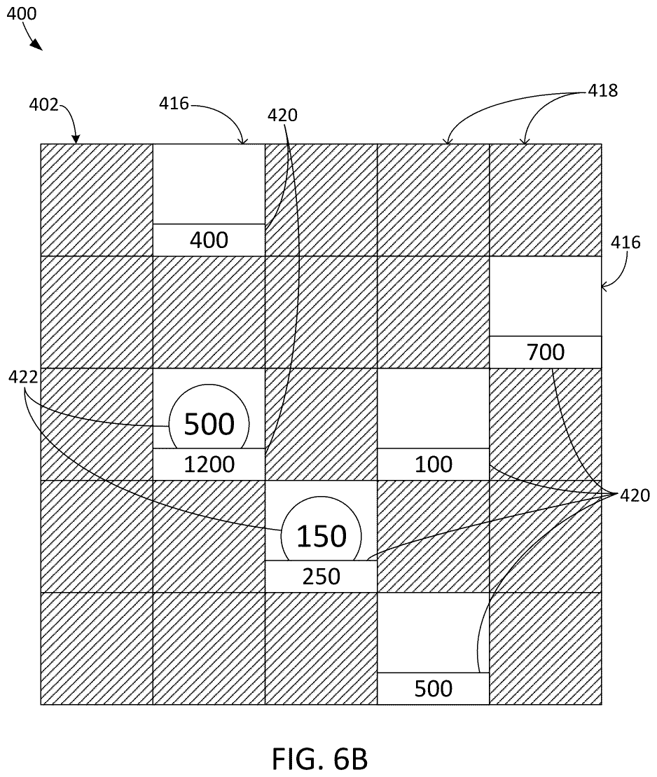

In some embodiments, in place of presenting new secondary game outcomes through selective population of held value-bearing symbols, the secondary game feature presents and updates the award indicia for the active symbol positions using meters, backgrounds, and/or other suitable presentation elements within the secondary game interface. FIGS. 6A and 6B depict an example embodiment in which the award indicia are held in position meters. More specifically, FIGS. 6A and 6B depict a game interface 400 for a multistage game conducted by a gaming system (e.g., the system shown in FIGS. 1 and 2). The game interface 400 is presented by a presentation assembly of a gaming machine within the gaming system. The presentation assembly is in communication with game-logic circuitry of the gaming system to provide the presentations and functionalities described herein.

The game interface 400 may be substantially similar to the game interface 300 shown in FIGS. 5A-5E unless otherwise noted. The game interface 400 includes a symbol array 402 formed from a plurality of symbol positions. In other embodiments, the game interface 400 may include additional, fewer, or alternative game and/or presentation elements, including those described elsewhere herein.

FIG. 6A depicts the game interface 400 in a trigger state of a primary game stage of the multistage game. The trigger state depicts a primary game outcome in which the symbol positions of the symbol array 402 are populated with randomly selected symbols. The symbols include six value-bearing symbols 412, each of which includes award indicia visually representing an award value associated with the respective symbol 412. Each value-bearing symbol 412 may be configured to populate the symbol array 402 for a single outcome or spin, or one or more value-bearing symbols 412 may be held within the array 402 to persist for a plurality of primary game outcomes.

In the trigger state, the primary game feature includes a secondary trigger event. In one example, the value-bearing symbols 412 are trigger symbols, and the number of value-bearing symbols 412 in the trigger state meets or exceeds a threshold number of trigger symbols. In another example, the trigger state is at the conclusion of the primary game feature. That is, the primary game feature has a limited duration (e.g., ten game outcomes), and the secondary trigger event is automatically initiated in response to the primary game duration expiring. In response to the secondary trigger event, the game-logic circuitry transitions from the primary game feature to the corresponding secondary game feature. In certain embodiments, the primary game feature is associated with a plurality of secondary game features, and the transition includes determining which secondary game feature to select for play. In one example, the secondary game feature is selected based on the characteristics and parameters of the secondary trigger event. In another example, the secondary game feature is selected based at least partially on random chance.

The presentation assembly is configured to animate a transition sequence to convert the game interface 400 from a primary game interface of the primary game feature to a secondary game interface of the secondary game feature. The transition sequence includes one or more animations to divide the symbol array 402 into active symbol positions and inactive symbol positions, which may include removing the inactive symbol positions from the interface 400. In the example embodiments, the active symbol positions are occupied by the value-bearing symbols 412 in the trigger state. In other embodiments, additional, fewer, or alternative symbol positions are selected to be active symbol positions through other suitable conditions, rules, and parameters of active position selection stored by the game-logic circuitry. In certain embodiments, the number of symbol positions may change to add or remove symbol positions from the interface 400 in the secondary game feature relative to the number of symbol positions in the primary game feature.

FIG. 6B depicts the game interface 400 in a secondary outcome state. The secondary outcome state follows the transition sequence to the secondary game feature and depicts an example secondary game outcome. The game interface 400 in the secondary game feature includes a plurality of active symbol positions 416 and a plurality of inactive symbol positions 418 that are visually distinct from the active symbol positions 416. In the example embodiment and in contrast to the embodiment shown in FIGS. 5A-5E, the value-bearing symbols 412 are removed from the game interface 400 in the secondary game feature. Instead, the active symbol positions 416 include award indicia 420 that act as meters for each of the active symbol positions 416 to monitor the current value. That is, in comparing FIGS. 6A and 6B, the award indicia of the value-bearing symbols 412 in the trigger state have been converted to the award indicia 420 of the secondary outcome state. The award indicia 420 is presented in a manner that enables the player to simultaneously track the current value of each active symbol position 416 and any new secondary game outcomes.

The secondary game outcome in the secondary outcome state includes selective population of the active symbol positions 416 with value-bearing symbols, modifier symbols, and/or other suitable symbols, such as special symbols that affect the duration of the secondary game feature or trigger a jackpot award. In the illustrated embodiment, two new value-bearing symbols 422 are included in the active symbol positions 416. Similar to the embodiment shown in FIGS. 5A-5E, the values indicated by the new value-bearing symbols are aggregated with the value indicated by the corresponding award indicia 420, and the award indicia 420 is updated accordingly. That is, the value-bearing symbols 422 having credit values of ‘500′ and ‘150′ are aggregated to result in new award indicia 420 indicating award values of ‘1700′ and ‘400′, respectively, in the corresponding active symbol positions 416. In other embodiments, the new value-bearing symbols 422 are applied to the award indicia 420 via additional or alternative mathematical and/or logical operations, including those described elsewhere herein.

The embodiments disclosed herein refer to various visual updates to graphical (or partially graphical) game interfaces, including animations, animation sequences, and the like. Such visual updates are performed through the game-logic circuitry retrieving stored graphical game assets and generating cohesive graphical game interfaces through the combination of the current game state and the retrieved game assets into video data for the presentation assembly. The video data is provided to the presentation assembly in a data structure recognized by the presentation assembly to convert the video data into visible outputs via physical components, such as light-emitting diodes (LEDs) arranged into a pixel matrix. Changes to the game interface include a comparison of the current state of the game to a prior state and adjusting the corresponding assets and resulting video to match the new game state to facilitate smooth transitions via the visible output of the presentation assembly. Animations may be stored as distinct, bespoke game assets and/or stored in an adaptable manner in which the animations are tailored to match the corresponding presentation and game assets. That is, if a game animation for an example game event is based on three symbols in a symbol array, the game-logic circuitry adapts the presentation of the animation based on the pixel locations of the three symbols within the interface such that the player can readily identify which symbols correspond to the game event depicted by the animation without storing a unique animation for every possible permutation of the game event. Accordingly, the animations and visual updates described herein are to be understood to include at least some pixel-level adaptation of the game state to the physical and/or addressable mediums on which the interfaces are ultimately presented (e.g., electronic display devices of a presentation assembly).

In the embodiments disclosed herein, each value-bearing symbol may be assigned a credit value that is displayed upon the symbol. The credit value may, for example, range from a minimum credit value to a maximum credit value and be based on the total amount wagered on the game. For example, if a player wagers a minimum of 100 credits, the assigned credit value may range from 100 to 1000 credits. And if a player wagers a maximum of 500 credits, the assigned credit value may proportionately increase and thereby range from 500 to 5000 credits. In some embodiments, the assigned value may be randomly selected from a list of possible multipliers of the total amount wagered on the game, for example, 13×, 2×, 3×, 4×, 5×, 10×, 15×, 20×, 50×, and 100×. In other embodiments, the value may be pre-assigned to each value-bearing symbol as part of the reel strip layouts of the game reels. In still other embodiments, the assigned value may be randomly selected before, during, or at the conclusion of a reel spin.

As disclosed in the embodiments herein, awards may be provided for each game outcome based on at least the remaining symbols. For example, line pays and scatter pays may be awarded for each game cycle outcome based on the symbols populating the symbol array. In some embodiments, the value-bearing symbols may not be associated with awards outside of the features described herein. In other embodiments, the value-bearing symbols may be included within line pays, scatter pays, and/or other suitable awards. For example, the value-bearing symbols may be treated as a special symbol, such as a wild symbol.

While the embodiments are largely described within the context of a base game, it is equally contemplated that the disclosed embodiments can be practiced within the context of a free game bonus without a wager between free game cycles.

The embodiments of the present invention provide an innovative procedure for a multistage aggregation of symbol values in a symbol array. Game-logic circuitry executing instructions in accordance with the embodiments present a visual display of spinning reels with clearly enumerated symbology that combine in readily understood arrangements to increase in value. An observer experiences excitement and anticipation as new symbols land in the array, the symbol array is reduced to an active set of positions, and new values and/or modifiers land in the active positions to aggregate or otherwise increase held award values displayed within the interface. In stark contrast to conventional reel-spinning games in which symbol images are evaluated for winning combinations by paytable rules, the disclosed embodiments provide immediately recognizable values in WYSIWYG display configurations while adding variability as to how the values to be awarded to the player are selected and accumulated.

The position selection, secondary value population, and value-aggregation procedures may be symbol-and game-agnostic. Themes and imagery of symbols and environment may be varied with no effect on the value-aggregation process. Or, if so desired, the criteria for value-aggregation may be modified in innumerable ways to produce new visual/animation effects and exciting summation sequences.

Further benefits are realized in increased computer processing efficiency, fewer rules to be evaluated, and simpler graphical representations. For example, in a conventional paytable evaluation, overlapping payline sections require multiple evaluation steps. Often, analysis is required to determine which payline results in the highest credit total, with the lesser value paylines being discarded but only after being evaluated—all this adds to processing overhead. Special symbols like wilds, multipliers, and scatter symbols can modify paytable values and may require separate, additional evaluation according to customized rule sets. All these procedures can be inherently more complex than simple aggregation (i.e., addition) and alteration of number values in combination with selectively reducing the active symbol positions. The embodiments disclosed herein represent a win-win: simpler, almost self-explanatory graphics combined with faster, more efficient processing. The inventive value-aggregation procedure can be implemented on the vast majority of casino gaming machines without requiring upgrades or modifications.

In this description, numerous specific details are set forth. However, it is understood that embodiments of the invention may be practiced without these specific details. In other instances, well-known circuits, structures, and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming machine comprising:
a presentation assembly configured to present a primary game interface including a plurality of symbol positions; and
game-logic circuitry in communication with the presentation assembly, the game-logic circuitry configured to:
cause the presentation assembly to present a trigger game outcome by populating the plurality of symbol positions with randomly-selected symbols, the randomly-selected symbols including at least one value-bearing symbol, each of the at least one value-bearing symbol having a respective award indicia visibly indicating an award value of the value-bearing symbol;
in response to detecting a trigger event from the trigger game outcome, cause the presentation assembly to animate the primary game interface to transition to a secondary game interface by visually updating the plurality of symbol positions into at least a set of active positions and a set of inactive positions visually distinct from the set of active positions, wherein the set of active positions include any symbol positions occupied by the at least one value-bearing symbol and are associated with the respective award indicia of the at least one value-bearing symbol;
cause the presentation assembly to present a secondary game outcome by selectively populating the set of active positions with award elements selected from a set of available award elements;
in response to the secondary game outcome including a first award element occupying a first active position of the set of active positions, cause the presentation assembly to update the award indicia associated with the first active position at least partially as a function of an award visibly indicated by the first award element; and
in response to an award event, cause the presentation assembly to present an award sequence for an award at least partially based on the award indicia associated with the first active position.

2. The gaming machine of claim 1, wherein the award visibly indicated by the first award element comprises at least one of an award value or a multiplier.

3. The gaming machine of claim 1, wherein the at least one value-bearing symbol remains within the set of active positions during the secondary game outcome.

4. The gaming machine of claim 1, wherein the at least one value-bearing symbol is hidden from the secondary game interface, the respective award indicia of the at least one value-bearing symbol remaining visible and associated with the symbol positions occupied by the at least one value-bearing symbol within the secondary game interface.

5. The gaming machine of claim 1, wherein the secondary game interface is associated with a secondary game feature, the secondary game feature having a limited duration at least initially defined by predetermined number of secondary game outcomes.

6. The gaming machine of claim 1, wherein the trigger event includes at least one of an outcome counter reaching a trigger threshold, one or more trigger symbols being detected within the trigger game outcome, or a predefined trigger combination of symbols being detected within the trigger game outcome.

7. The gaming machine of claim 1, wherein the primary game interface is associated with a primary game feature having a primary duration active for game outcomes of the primary game feature, and wherein the primary duration is suspended in response to transitioning to the secondary game interface and resumes in response to transitioning back to the primary game interface.

8. A method for operating a gaming machine of a gaming system, the gaming system including a presentation assembly of the gaming machine and game-logic circuitry in communication with the presentation assembly, the method comprising:
presenting, by the presentation assembly, a primary game interface including a plurality of symbol positions; and
causing, by the game-logic circuitry, the presentation assembly to present a trigger game outcome by populating the plurality of symbol positions with randomly-selected symbols, the randomly-selected symbols including at least one value-bearing symbol, each of the at least one value-bearing symbol having a respective award indicia visibly indicating an award value of the value-bearing symbol;
in response to detecting a trigger event from the trigger game outcome, causing, by the game-logic circuitry, the presentation assembly to animate the primary game interface to transition to a secondary game interface by visually updating the plurality of symbol positions into at least a set of active positions and a set of inactive positions visually distinct from the set of active positions, wherein the set of active positions include any symbol positions occupied by the at least one value-bearing symbol and are associated with the respective award indicia of the at least one value-bearing symbol;
causing, by the game-logic circuitry, the presentation assembly to present a secondary game outcome by selectively populating the set of active positions with award elements selected from a set of available award elements;
in response to the secondary game outcome including a first award element occupying a first active position of the set of active positions, causing, by the game-logic circuitry, the presentation assembly to update the award indicia associated with the first active position at least partially as a function of an award visibly indicated by the first award element; and
in response to an award event, causing, by the game-logic circuitry, the presentation assembly to present an award sequence for an award at least partially based on the award indicia associated with the first active position.

9. The method of claim 8, wherein the award visibly indicated by the first award element comprises at least one of an award value or a multiplier.

10. The method of claim 8, wherein the at least one value-bearing symbol remains within the set of active positions during the secondary game outcome.

11. The method of claim 8, wherein the at least one value-bearing symbol is hidden from the secondary game interface, the respective award indicia of the at least one value-bearing symbol remaining visible and associated with the symbol positions occupied by the at least one value-bearing symbol within the secondary game interface.

12. The method of claim 8, wherein the secondary game interface is associated with a secondary game feature, the secondary game feature having a limited duration at least initially defined by predetermined number of secondary game outcomes.

13. The method of claim 8, wherein the trigger event includes at least one of an outcome counter reaching a trigger threshold, one or more trigger symbols being detected within the trigger game outcome, or a predefined trigger combination of symbols being detected within the trigger game outcome.

14. The method of claim 8, wherein the primary game interface is associated with a primary game feature having a primary duration active for game outcomes of the primary game feature, and wherein the primary duration is suspended in response to transitioning to the secondary game interface and resumes in response to transitioning back to the primary game interface.

15. A gaming system comprising:
a gaming machine including a presentation assembly configured to present a primary game interface including a plurality of symbol positions; and
game-logic circuitry in communication with the presentation assembly, the game-logic circuitry configured to:
cause the presentation assembly to present a trigger game outcome by populating the plurality of symbol positions with randomly-selected symbols, the randomly-selected symbols including at least one value-bearing symbol, each of the at least one value-bearing symbol having a respective award indicia visibly indicating an award value of the value-bearing symbol;
in response to detecting a trigger event from the trigger game outcome, cause the presentation assembly to animate the primary game interface to transition to a secondary game interface by visually updating the plurality of symbol positions into at least a set of active positions and a set of inactive positions visually distinct from the set of active positions, wherein the set of active positions include any symbol positions occupied by the at least one value-bearing symbol and are associated with the respective award indicia of the at least one value-bearing symbol;
cause the presentation assembly to present a secondary game outcome by selectively populating the set of active positions with award elements selected from a set of available award elements;
in response to the secondary game outcome including a first award element occupying a first active position of the set of active positions, cause the presentation assembly to update the award indicia associated with the first active position at least partially as a function of an award visibly indicated by the first award element; and
in response to an award event, cause the presentation assembly to present an award sequence for an award at least partially based on the award indicia associated with the first active position.

16. The gaming system of claim 15, wherein the award visibly indicated by the first award element comprises at least one of an award value or a multiplier.

17. The gaming system of claim 15, wherein the at least one value-bearing symbol remains within the set of active positions during the secondary game outcome.

18. The gaming system of claim 15, wherein the at least one value-bearing symbol is hidden from the secondary game interface, the respective award indicia of the at least one value-bearing symbol remaining visible and associated with the symbol positions occupied by the at least one value-bearing symbol within the secondary game interface.

19. The gaming system of claim 15, wherein the secondary game interface is associated with a secondary game feature, the secondary game feature having a limited duration at least initially defined by predetermined number of secondary game outcomes.

20. The gaming system of claim 15, wherein the trigger event includes at least one of an outcome counter reaching a trigger threshold, one or more trigger symbols being detected within the trigger game outcome, or a predefined trigger combination of symbols being detected within the trigger game outcome.

21. The gaming system of claim 15, wherein the primary game interface is associated with a primary game feature having a primary duration active for game outcomes of the primary game feature, and wherein the primary duration is suspended in response to transitioning to the secondary game interface and resumes in response to transitioning back to the primary game interface.
